(19) United States
(12) Patent Application Publication
(10) Pub. No.: US 2023/0051898 A1
(43) Pub. Date: Feb. 16, 2023

(54) Stationary automated device for lower limb rehabilitation

(71) Applicant: Prodromus sp. z o.o, Krakow (PL)

(72) Inventor: Grzegorz PIATEK, Krakow (PL)

(21) Appl. No.: 17/791,530

(22) PCT Filed: Jan. 6, 2021
(86) PCT No.: PCT/PL2021/000001

§ 371 Date: Jul. 7, 2022

(30) Foreign Application Priority Data
Jan. 7, 2020 (PL) P.432504

(51) Int. Cl. A61H 3/00; A61H 1/02

(52) U.S. Cl. CPC A61H 3/00; A61H 1/0262; A61H 2201/164; A61H 2201/0192; A61H 2201/5007; A61H 2201/5064; A61H 2201/5061; A61H 2203/0431; A61H 2201/1215; A61H 2201/1676; A61H 2201/1635; A61H 2230/805

(57) ABSTRACT

Two vertical front posts and two vertical rear posts are mounted on a flat platform of the automated device. The front posts mounted in the horizontal guide are symmetrically moved by the spacing adjustment mechanism within the range between the position of the joined front posts to a dimension between their inner surfaces equal to the width of the wheelchair, and the moved apart position to a dimension where the width dimension of the wheelchair is located between the mechanical legs suspended on the front posts. On the inner surfaces of the front posts, there are vertical guides with a screw drive mechanism for pelvic height adjustment. The mechanical legs girdle the patient's lower limbs from the outside by pelvic control units that induce a symmetrically alternating movement of the hip joint hinges in both mechanical legs with ellipsoid trajectories, and by adjustable thigh and shin connectors and foot connectors.

The invention relates to a stationary automated device for the rehabilitation of lower limbs, designed specifically for the treatment of adult patients suffering from a severe motor disability or impaired control of lower limbs mobility. The automated device may be used for cerebral palsy patients, suffering from neurological diseases, such as Parkinson's disease, paraparesis, following vehicular trauma, for people with lower limb muscular atrophy after extended periods of lying or sitting.

Many devices are known that help regaining fitness and coordination of body movement while walking. A special group consists of solutions forcing passive exercises with drives for programme-controlled movements of hip, knee and talocrural joints, performed in the sagittal plane without the feet contacting the ground, i.e. without being loaded by body weight. The device presented in Polish patent description PL224669 comprises a tripod with two posts accommodating vertical guides for mechanical leg units. The mechanical legs externally girdle patient's lower limbs with hip joint brackets, thigh and shin connectors of adjustable lengths and foot connectors. These components are equipped with lateral hip pressing members, thigh holders, shank holders and foot hold, respectively, coupled into joint braces for patient's lower limbs. Behind the hip joint brackets is situated a back hold having a depth adjustable in the sagittal plane and fixed so as to tilt relative to perpendicular vertical and horizontal axes. A seat is connected to the tripod, which allows for sitting and standing up exercises to be performed, and, when removed, for moving the legs by a patient when standing, without a lift, however, to help lift the patient to a vertical position. Horizontally positioned common rotation axis of the hip joints enables alternate movement of the mechanical leg tilt units only in the sagittal planes, which does not reflect anatomical shifts of these joints also in the sagittal and frontal planes that occur during walking. Hip joint brackets are rotatably mounted in vertical guides to the tripod, which allows them to be moved to the sides and makes it easier to introduce the patient into the device, either in a standing position or in a wheelchair. All drives of the moving parts of the device, namely adjustable connectors and hinges in mechanical leg units and back hold are controlled by signals from a software-equipped computer, without the position and strength thereof being controlled by measuring sensors.

Moreover, patent description EP3290016 (U.S. Ser. No. 10/413,470B2) discloses a stationary automated device for lower limb rehabilitation, wherein mechanically induced movements of the limbs are performed with the whole body tilted in the range from horizontal to vertical, selected according to the current severity of the patient's motor disability. The device has two vertical posts fixedly connected to a platform with guides, in which a tilt axis of the back section of the bed is slidably suspended, and to which mechanical leg units are connected on the side of the pelvic rim. The mechanical leg unit described in detail in the description includes, in addition to the elements matching those present in human limbs: pelvis as a base for supporting hip joints, thigh and shin connectors with manually adjustable lengths, foot connectors, hip, knee and talocrural joint hinges—connecting components in the form of: hip pressing members, thigh and shin holders and foot supports. Moreover, the mechanical legs are equipped with drive and regulation mechanisms which allow for adjusting the dimensions to match those of the patient and to perform angular displacements specified in the computer programme. The patient foot holds have integrated pressure sensors, whose signal is transmitted to a software-equipped computer and evaluated relative to the body tilt angle.

The action of walking imposes a complex, bilaterally symmetrical pelvic movement pattern. At each of the alternating steps, the left and right hip joints move symmetrically and three-dimensionally in the sagittal and frontal planes, following an ellipsoid trajectory in the sagittal plane view.

The solution according to the American inventive application US2014228720A1 provides a movement partially similar to the natural pattern of hip joint movement when walking, obtained by using a pelvic control unit, but in conditions where the patient is walking with their feet on a treadmill. The unit comprises a guide that is horizontal and perpendicular to the y-z sagittal plane, fixed to the tripod by a driveless four-bar linkage, mitigated only by the cable mechanism. Two telescopic hip brackets are slidably mounted on the guide, positioned parallel to the vertical sagittal y-z plane and connected to actuators that press the brackets against the hip joints of the patient's pelvis by a flexible holder, while sliding both brackets together on the guide. Each bracket has integrated screw ball actuators, changing the length of each hip bracket which results in a change of the position in the sagittal plane of the adjacent hip joint, which is encompassed by the adjacent section of the flexible hip holder. Only the “z” and “x” coordinates of the mechanical leg hip joint, i.e. in the horizontal transverse plane, are controllable in the pelvic control unit. The vertical component “y” of hip joint movement is non-controlled; it is possible to shift it within the play of vertical movement of the reduced load linkage of the guide suspension and the flexibility of the hip holder. The other movable parts of the mechanical legs are suspended from the ends of the hip brackets of the pelvic control unit.

The spatial structure of human pelvic movements during walking is described in detail e.g. in patent description U.S. Pat. No. 7,125,388B1. This description also discloses a device that provides a natural kinematics of pelvic movements by a controlled drive of the position of each hip joint hinge mounted to the hip pressure band. Programmed change of the spatial position of the left and right joint hinges is performed using a pelvic control unit in which three linear actuators, pneumatic, hydraulic or electric, are connected to the hinge of each joint, which are fixed with piston rods to each hinge. Two of the three actuators are mounted in a generally horizontal plane, while the third one is slanted upwards. The description describes are preferable the use of pneumatic actuators, which are controlled according to numerical software of piston rod extension and force thereof. These parameters are controlled by linear potentiometers and pressure sensors integrated with the actuators. The drive unit actuated by compressed air is not very accurate when it comes to following a meticulous implementation of the programmed force model with movement speed.

The automated device for rehabilitation of lower limbs according to the invention is designed to facilitate the activities of introducing and “rigging” the patient into the braces inside the exercising space, to ensure full analogy of the control of mechanically induced movements with the anatomical walking model, especially in terms of pelvic movement, to increase the safety level of the patient's rehabilitation and to enable the adjustment of software parameters through ongoing monitoring of positions and forces present in major components of the design of the automated device.

The solution according to this invention has many features in common with the known devices described above, while it also comprises a tripod with two vertical guides for suspending mechanical legs equipped with pelvic control units and tiltably actuated lower limb joint braces, and it has an elastic back hold, moreover, the drives of the moving parts of the automated device are controlled by signals from a software-equipped computer to monitor positions and forces by measuring sensors. The automated device of to the invention is characterised in that the tripod is in the form of a flat platform with two vertical front posts and two vertical rear posts positioned symmetrically to the sagittal plane. The front posts are slidably mounted in the horizontal guide provided inside the platform in the frontal plane and they are symmetrically moved by the spacing adjustment mechanism within the range encompassing the position of the joined front posts to a dimension between their inner surfaces equal to the width of the wheelchair, and the moved apart position to a dimension where the width dimension of the wheelchair is located between the mechanical legs, which are suspended on the front posts. Moreover, each front post on the inner surface, parallel to the sagittal plane, has integrated vertical guides with a pelvic control unit screw drive. The pelvic control unit is connected to the hip joint hinge of the mechanical leg coupled to the patient by the thigh, shin and foot holders. The rear posts are fixedly mounted to the platform with the inner surfaces spaced apart by a distance equal to the dimension between joined front posts, and, moreover, they have integrated vertical guides for two symmetrically actuated lift brackets. The lift brackets are connected at their upper ends by supporting members and two parallel bars with the lifter positioned forward in the sagittal plane. The lifter ends with a crossbar with two handles for the patient's hands. The back hold with the elastic cushion is mounted at the end of the tiltable supporting member, connected with the other end by a hinge with a vertical rotation axis to a slider embedded in the vertical guide of one of the lift brackets.

In a preferred embodiment, the front post spacing adjustment mechanism comprises a servomotor actuating, by a pulley transmission belt, with a double-toothed belt, two screw transmissions, whose screws, positioned perpendicularly and extending to opposite sides from the sagittal plane, are connected to the nuts mounted to the front posts.

In another preferred embodiment, the pelvic control unit has a spacer plate connected by a screw drive integrated in the front post, and it has a support mounted to the spacer plate with a drive consisting of a servomotor, belt and screw transmissions and horizontal guides which are located in a plane parallel to the sagittal plane. An elliptical movement plate is attached to the support, which is connected by supporting members to the hip joint hinge and by the tilt unit to the mechanical leg hip joint.

In another preferred embodiment, supporting members are fixedly mounted to the lift brackets that extend towards the front posts and are connected at the ends by two parallel bars. On the front bar, there is mounted on a bearing a lifter composed of two parallel brackets, which at the ends above the front posts are connected by a crossbar with handles for patient's hands. At the ends located at the rear bar, in turn, the brackets are connected to a patient weight sensor with a display mounted on said rear bar.

A further improvement consists in the back hold, which in a preferred embodiment has horizontal guides of the lifter ending in a elastic cushion. The cushion is mounted on a bearing plate yieldingly connected to the lifter by a vertical tilt axis, a supporting member and a nut with a lifting screw, which is actuated by a servomotor via the belt transmission. On the casing of the hold there is a hold handle and a controller for locking the support position.

Another improvement consists in the brackets of the tilt units that actuate the hip, knee and ankle joint hinges being provided with cut-outs increasing their susceptibility to elastic strain, and in resistance strain gauges being attached with an adhesive on the front and side faces of said brackets, whose signals are transmitted to the controller of the automated device.

The design of the automated device according to the invention provides the following:

with the back hold moved to the side, substantial facilitation of the operation of introducing and “rigging” the patient with support components and connecting them through the braces with the mechanical legs, with bilateral access to the patient being brought into a standing position or in a wheelchair, and depending on the severity of disability, with lifting support and, optionally, supporting of the patient in the exercising position,

performing exercises with forced rotation movement of the pelvis without the hips being held by a holder and in conditions without the patient contacting the ground, wherein the patient stands on movable foot holds with their limbs being connected by thigh, shin and foot holders to both of the mechanical legs of the automated device and maintains a vertical position of the body during the exercises by: suspending the rehabilitation harness to the lift crossbar and/or grasping the handles extending in front of the patient connected to the pelvic control units,

improved safety level of the exercises through ongoing monitoring of the forces occurring in major components of mechanical legs and introduction of proper adjustment of movements according to the controller's software.

The solution according to the invention is illustrated by the description of an embodiment of the automated device shown in the drawing, wherein the figures illustrate the following:

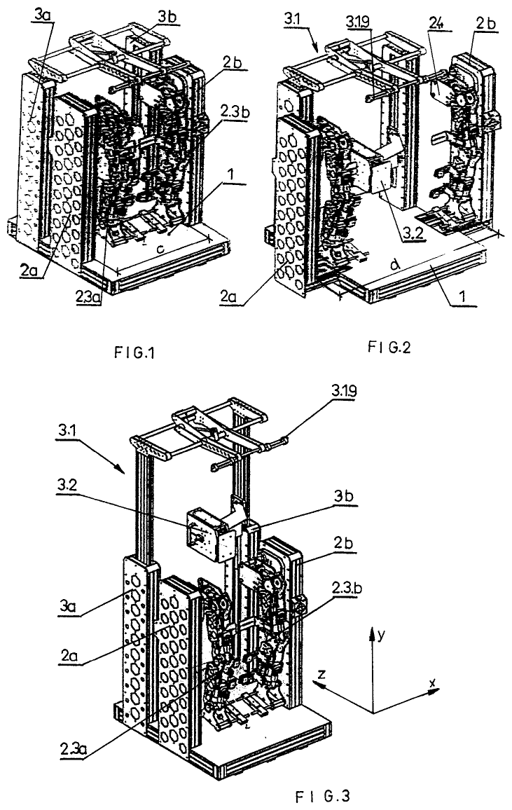

FIG. 1, FIG. 2 and FIG. 3—a top perspective view of the automated device, in the following order: with the front posts joined and with the lift lowered, with the front posts moved apart, and with the front posts joined and the lift raised,

FIG. 4 and FIG. 5—front and side views of the automated device with the front posts moved apart and the lift raised,

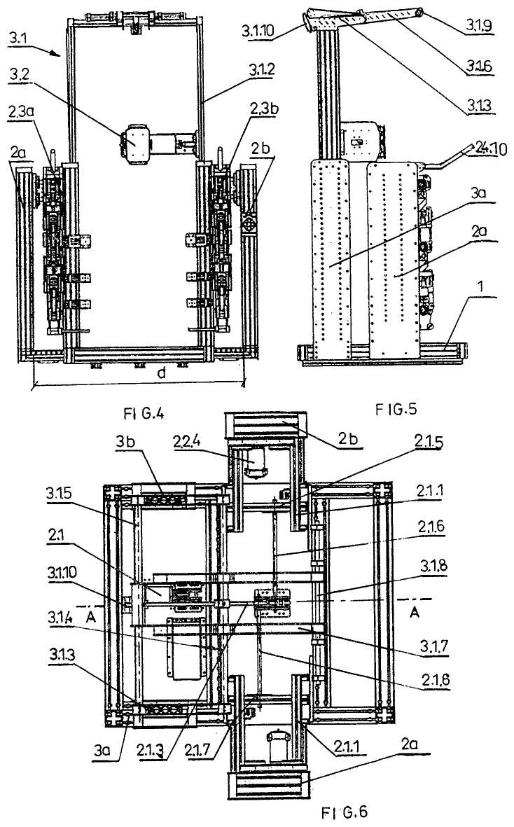

FIG. 6—a top view with the front posts moved apart and the platform cover removed,

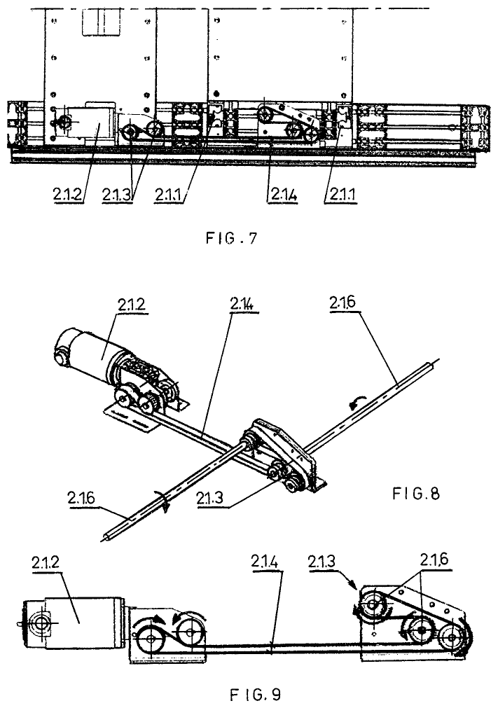

FIG. 7—a cross-section view of the front post movement drive through A-A line of FIG. 6,

FIG. 8—a perspective view of the components of the spacing drive,

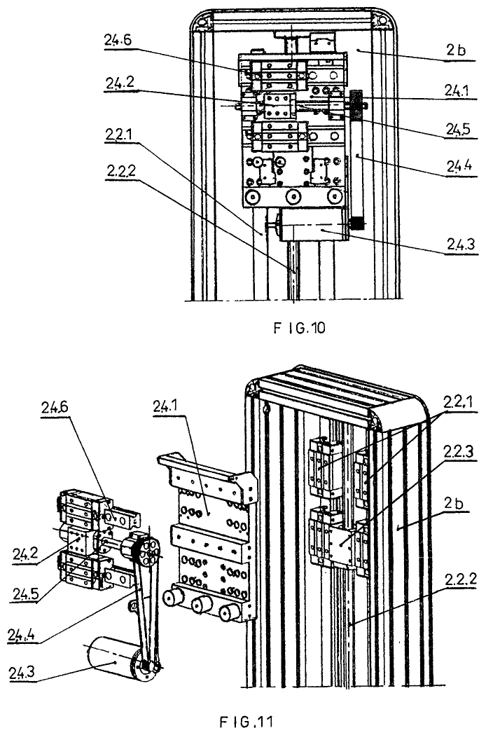

FIG. 9—a side view of the components of the spacing drive,

FIG. 10—a front view of the pelvic control unit system with the tilt unit removed,

FIG. 11—a perspective exploded view of the pelvic control unit,

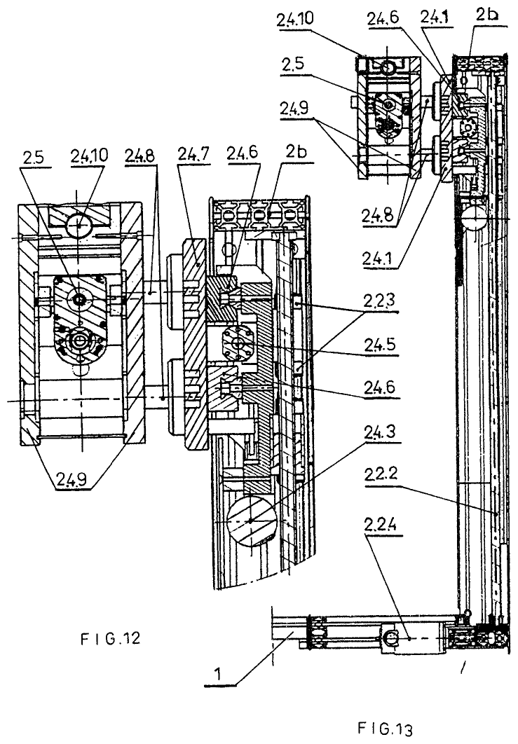

FIG. 12—a vertical cross-section view of the pelvic control unit,

FIG. 12—a vertical cross-section view of the front post and pelvic control unit

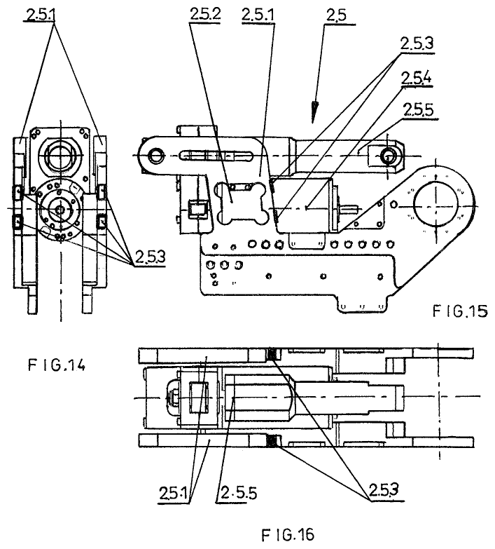

FIG. 14 to FIG. 16—a front, side and top views, respectively, of the tilt unit, with the indication of where the resistance strain gauges are attached with an adhesive,

FIG. 17—a perspective view of the upper part of the lift,

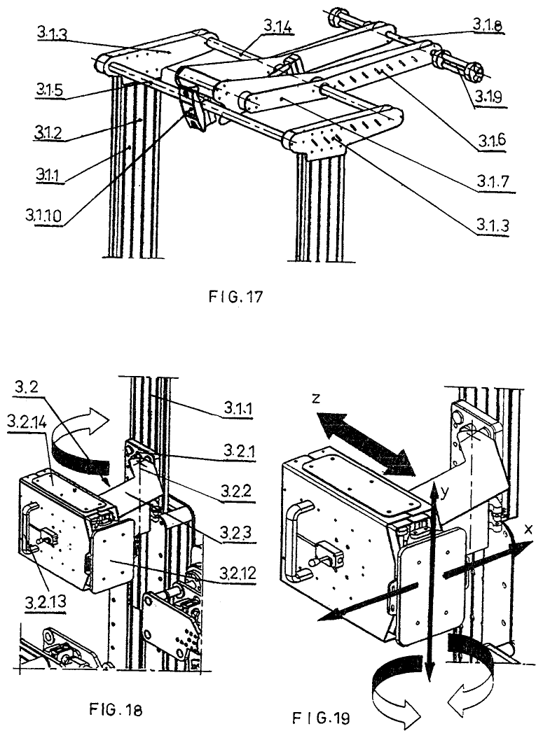

FIG. 18 and FIG. 19—perspective views of the back hold with the indication of tilts and shifts,

FIG. 20—a perspective exploded view of the back hold,

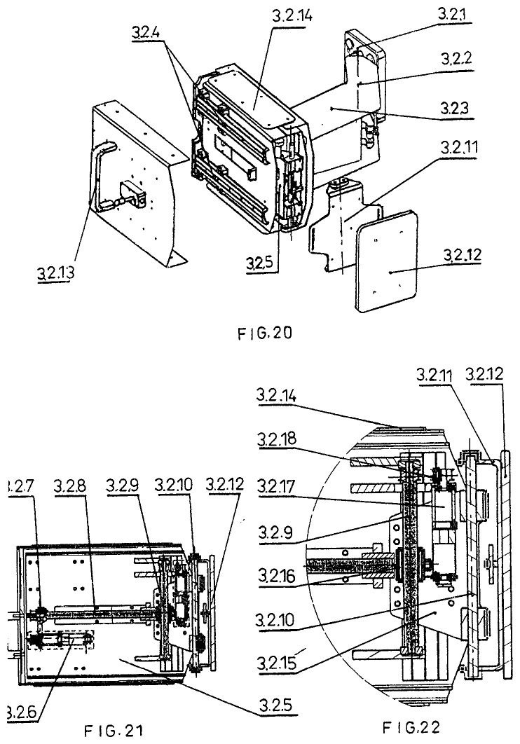

FIG. 21 and FIG. 22—a vertical cross-section of the back hold and an enlarged view of the section with the elastic cushion mounted on the lifter,

FIG. 23—a front view of the automated device with the following indicated by the dotted line: patient's silhouette during lifting and weighing, suspended by rehabilitation harness and strap ropes on the crossbar of the lift and during the performance of exercises, with hands on the handles of the pelvic control unit,

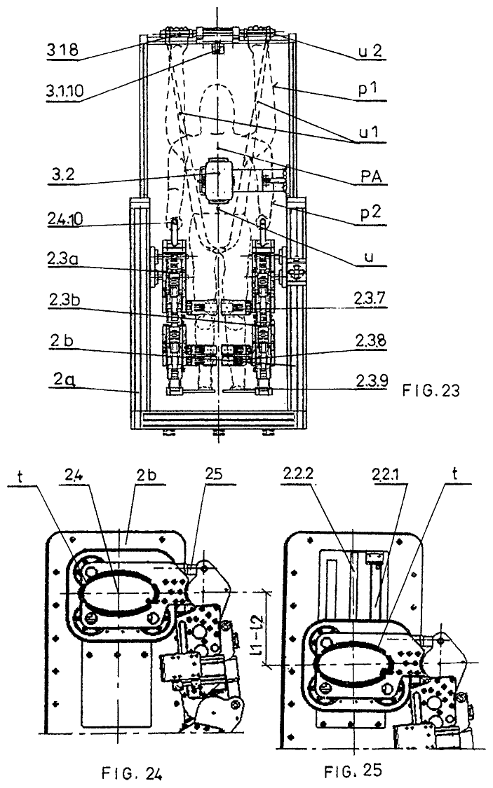

FIG. 24 and FIG. 25—a view of the pelvic control unit shown from the centre of the automated device, successively in the extreme positions of the pelvic joint height, selected for a tall and short patient, with the elliptical movement trajectory indicated,

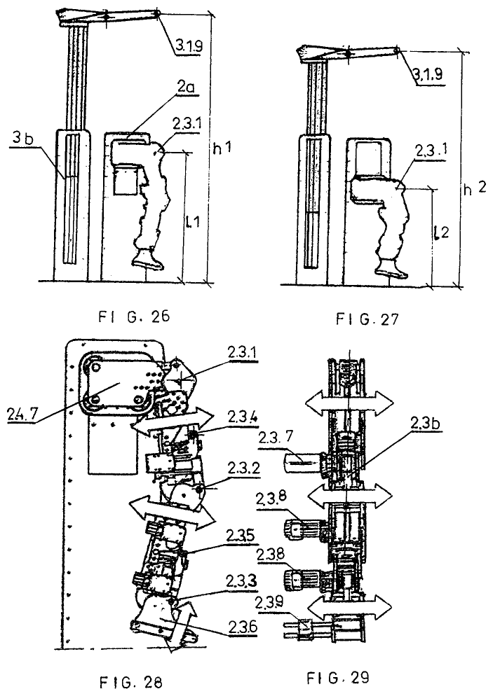

FIG. 26 and FIG. 27—schematic side views of the automated device in the positions of the pelvis and lift adjusted for a tall and short patient, respectively,

FIG. 28 and FIG. 29—side and front views of the mechanical legs with the directions of measuring forces with resistance strain gauges indicated.

In the following description of an exemplary embodiment of the automated device, due to the repeated names of technical means, such as servomotor, screw, guide, belt transmission, their instances in different units has been differentiated by adding a number inside quotation marks to the name, for example “screw “2””.

FIGS. 1 to 5 of the drawing provide a comprehensive picture of the external structure of the rehabilitation automated device having the inventive characteristics. Symmetrically to the sagittal plane of the automated device, defined by the y-z Cartesian system axes, two vertical front posts 2a and 2b and two vertical rear posts 3a and 3b are integrated on the flat platform 1.

The front posts 2a and 2b are slidably mounted in the frontal plane x-y and inside platform 1 of the horizontal guide “1” 2.1.1. Said posts are moved symmetrically by the spacing adjustment mechanism 2.1.2 within the range between the position of the joined front posts 2a and 2b to a dimension “c” between their inner faces equal to the width of the wheelchair, and the moved apart position to a dimension “d”, where the width dimension of the wheelchair is located between the mechanical legs 2.3a and 2.3b suspended in vertical guides “1” 2.2.1 on the inner faces of front posts 2a and 2b. The front post spacing adjustment mechanism 2.1, with the design shown in FIG. 6 to FIG. 9, comprises a servomotor “1” 2.1.2 which actuates, by pulley transmission belt 2.1.3 with a double-toothed belt 2.1.4 two screw transmissions “1” 2.1.5, whose screws 2.1.6, positioned perpendicularly and to opposite sides of the sagittal plane y-z are connected with nuts “1” 2.1.7 mounted to both front posts 2a and 2b. On the inner faces of both front posts 2a and 2b there are vertical guides “1” 2.2.1 of the pelvic height adjustment mechanism 2.2, each of which is composed of a servomotor 2.2.4 that actuates by the screw “2” 2.2.2 the nut “2” 2.2.3 mounted to the spacer plate 2.4.1 of the pelvic control unit 2.4 (FIG. 10 to FIG. 13). On the spacer plate 2.4.1 a support 2.4.2 is mounted with horizontal drive composed of: servomotor “3” 2.4.3, belt transmission “1” 2.4.4 and screw transmission “2” 2.4.5 and horizontal guides “2” 2.4.6 located in a plane parallel to the sagittal plane y-z. An elliptical movement plate 2.4.7 is attached to the support 2.4.2, which is connected by supporting members “1” 2.4.8 to the hip joint hinge brackets 2.4.9 and by the tilt unit 2.5 to the hip joint hinge 2.3.1 of the mechanical leg 2.3a and 2.3b. The mechanical legs 2.3a and 2.3b girdle the patient's PA lower limbs from the outside by: pelvic control units 2.4 that induce a symmetrically alternating movement of the hip joint hinges 2.3.1 and by adjustable thigh 2.3.4 and shin 2.3.5 connectors and foot connectors 2.3.6 actuated by tilt units 2.5. The movement of the hip joint hinge brackets 2.4.9 has spatial trajectories t that are ellipsoid in the sagittal plane view y-z with the longitudinal axis being horizontal. The trajectories t are defined by integrating the controlled movements: vertical, by the pelvic height adjustment 2.2 and horizontal, by the support 2.4.2 of the pelvic control unit 2.4. The tilt units 2.5 are mounted in the mechanical legs 2.3a and 2.3b, successively: between hip joint hinge brackets 2.3.1, adjustable thigh 2.3.4 and shank 2.3.5 connectors and the foot connector 2.3.6, giving each of them, by a servomotor “4” 2.5.4 and a screw actuator 2.5.5 a relative tilt angle, determined by the software of the controller. The brackets 2.5.1 of all of the tilt units 2.5 are provided with cut-outs 2.5.2 that increase their susceptibility to elastic strain. On the front and side faces of said brackets 2.5.1, there are resistance strain gauges 2.5.3 attached with an adhesive, whose signals are transmitted to the controller of the automated device, where, analysed by the control system software in terms of values and direction, they provide an image of the forces present in individual joints and braces of the mechanical legs 2.3a and 2.3b both in the sagittal plane y-z and in the frontal plane x-y, which allows for introducing the required parameter adjustments to a safe extent.

Rear posts 3a and 3b are fixedly attached to platform 1, allowing for the patient PA to be lifted into the exercising position without their feet contacting the platform 1, and for the patient PA to be weighed. On the inner faces, rear posts 3a and 3b have vertical guides “2” 3.1.1 for the two symmetrically actuated lift brackets 3.1.2, which at their upper ends are connected by supporting members “2” 3.1.3 extending towards front posts 2a and 2b (FIG. 17). Supporting members “2” 3.1.3 at their ends are connected by two parallel front 3.1.4 and rear 3.1.5 rods. On the front bar 3.1.4 there is mounted on a bearing a lifter “1” 3.1.6 composed of two parallel brackets 3.1.7, which at their ends above front posts 2a and 2b are connected by a crossbar 3.1.8 with two handles “2” 3.1.9 for the patient's PA hands. Rear ends of the lifter “1” 3.1.6 connected to a patient weight sensor 3.1.10 with a value display mounted on the rear bar 3.1.5.

In the vertical guide “2” 3.1.1 of one of lift brackets 3.1.2 there is mounted a slide 3.2.1 with a hinge 3.2.2 having a vertical rotation axis, connected by tiltable supporting member 3.2.3 to the back hold 3.2 (FIG. 18), which serves as an additional support point and, optionally, upholding a patient PA in conditions of advanced illness. During the introduction of the patient PA into the exercise area of the automated device, the back hold 3.2 is moved to the side beyond the lift bracket 3.1.2 on which it is suspended and locked in this position, which provides full bilateral access to the exercise area and to the patient PA. The position of the back hold 3.2 is adjustable (FIG. 19) in the sagittal plane y-z and tiltable relative to the vertical y and horizontal x axes of the spatial Cartesian coordinate system x,y,z. In the casing 3.2.14 of the back hold 3.2 there are mounted horizontal guides “3” 3.2.4 of the lifter “2” 3.2.5, which ends with a bearing plate 3.2.11 and a elastic cushion 3.2.12. The extension of the lifter “2” 3.2.5 is performed by the servomotor “5” 3.2.6, belt transmission “2” 3.2.7 and screw transmission 3.2.8 (FIG. 20, 21, 22). The bearing plate 3.2.11 is connected to the lifter “2” 3.2.5 by a vertical tilt axis 3.2.10, which is fixed in the supporting member “4” 3.2.15 on rubber yielding parts. A nut 3.2.16, which interacts with the vertical lifting screw 3.2.9, actuated by the servomotor “6” 3.2.17 connected to the supporting member “4” 3.2.15 is attached to the supporting member “4” 3.2.15. The ends of the lifting screw 3.2.9 are mounted on a bearing on the lifter “2” 3.2.5. The yielding parts of the tilt axis 3.2.10 and nut 3.2.16 allow movement of the body of the patient PA adjacent to the back hold 3.2 according to the controlled elliptical movement of the pelvis during walking, and the support depth is coupled with the pelvic height adjustment. The solution allows for rotation of the elastic cushion 3.2.12 relative to the vertical axis y in the sagittal plane y-z between −10° and +10° and vertical translation between −2 and +2 cm, which corresponds to vertical oscillations of the patient's PA centre of gravity during walking. At the back, a control panel with control buttons is mounted to the hold 3.2.14 casing, and at the side, a handle with a controller for locking the position, which is implemented as a gas spring.

The following figures of the drawing present utility characteristics of using the automated device during rehabilitation exercises. In the front view of FIG. 23, the positions of the patient's PA hands are indicated with a dotted line in the following situations:
p1—during lifting, putting on the rehabilitation harness u, thigh 2.3.7, shin 2.3.8 and foot 2.3.9 holders, and weighing, when the patient PA, depending on the severity of paresis, is using their hands to grasp the handles “2” 3.2.9 of the crossbar 3.1.8 of the lift 3.1 or is lifted in the rehabilitation harness attached by strap ropes u1 and eyelets u2 on the handles “2” 3.2.9 of the crossbar 3.1.8,
p2—while performing the exercises, when the patient PA is brought into a standing position by the thigh 2.3.7, shank 2.3.8 and feet 2.3.9 holders and the back hold 3.2, optionally, suspended in the rehabilitation harness u, is holding with their hands the handles “1” 2.4.10 of the pelvic control unit 2.4.

FIGS. 24 and 25 and FIGS. 26 and 27 show the extreme heights of the hip joint hinge 2.3.1 height adjustment and of the handle “2” 3.2.9 of the lift 3.1, adjusted for a tall l1 and h1 and short l2 and h2 patient PA, respectively. FIGS. 24 and 25 further show an elliptical trajectory t of hip joint hinge bracket 2.4.9 movement. The automated device changes the exercising height of the patient PA in an automated manner, based on the inference mechanism, and is mechanically and electronically coupled with the back hold 3.2 and the pelvic height adjustment mechanism 2.2. Once the patient PA is introduced into the exercise area, they are lifted by the lift 3.1 so that in the upright position their feet are a short distance above platform 1, with the length of adjustable thigh 2.3.4 and shank i 2.3.5 connectors being adjusted accordingly. The settings require that the asymmetry of the patient's PA lower limbs be taken into account, even if part or all of the limb is missing.

In the last figures FIGS. 28 and 29, arrows indicate places and directions of forces measured by resistance strain gauges 2.5.3 on mechanical legs 2.3a and 2.3b. All movements of the automated device are controlled by computer software and monitored using sensors. During the first exercises of the patient PA, their dimensions are entered into the database, which allows for setting the required parameters of the automated device at the beginning of each subsequent exercise.

### FIGURE REFERENCE LIST

1. Platform
2. Front post, 2a—left, 2b—right
   2.1 Front post spacing adjustment mechanism
      2.1.1 Horizontal guide “1”
      2.1.2 Servomotor “1”
      2.1.3 Pulley transmission belt
      2.1.4 Double-toothed belt
      2.1.5 Screw transmission “1”
      2.1.6 Screw “1”
      2.1.7 Nut “1”
   2.2 Pelvic height adjustment mechanism
      2.2.1 Vertical guide “1”
      2.2.2 Screw “2”
      2.2.3 Nut “2”
      2.2.4 Servomotor “2”
   2.3 Mechanical leg 2.3a—left, 2.3b—right
      2.3.1 Hip joint hinge
      2.3.2 Knee joint hinge
      2.3.3 Ankle joint hinge
      2.3.4 Adjustable thigh connector
      2.3.5 Adjustable shank connector
      2.3.6 Foot connector
      2.3.7 Thigh holder
      2.3.8 Shank holder
      2.3.9 Foot holder
   2.4 Pelvic control unit
      2.4.1 Spacer plate
      2.4.2 Support
      2.4.3 Servomotor “3”
      2.4.4 Belt transmission “1”
      2.4.5 Screw transmission “2”
      2.4.6 Horizontal guide “2”
      2.4.7 Elliptical movement plate
      2.4.8 Supporting member “1”
      2.4.9 Hip joint hinge bracket
      2.4.10 Handle “1”
   2.5 Tilt unit
      2.5.1 Bracket
      2.5.2 Cut-out
      2.5.3 Resistance strain gauge
      2.5.4 Servomotor “4”
      2.5.5 Screw actuator
3. Rear post, 3a—left, 3b—right
   3.1 Lift
      3.1.1 Vertical guide “2”
      3.1.2 Lift bracket
      3.1.3 Supporting member “2”
      3.1.4 Front bar
      3.1.5 Front bar
      3.1.6 Lifter “1”
      3.1.7 Lifter bracket
      3.1.8 Crossbar
      3.1.9 Handle “2”
      3.1.10 Patient weight sensor
   3.2 Back hold
      3.2.1 Slider
      3.2.2 Hinge
      3.2.3 Supporting member “3”
      3.2.4 Horizontal guide “3”
      3.2.5 Lifter “2”
      3.2.6 Servomotor “5”
      3.2.7 Belt transmission “2”
      3.2.8 Screw transmission “3”
      3.2.9 Lifting screw
      3.2.10 Tilt axis
      3.2.11 Bearing plate
      3.2.12 Elastic cushion
      3.2.13 Hold handle
      3.2.14 Hold casing
      3.2.15 Supporting member “4”
      3.2.16 Nut “3”
      3.2.17 Servomotor “6”
      3.2.18 Belt transmission “3”
x, y, z Cartesian coordinate system axes
y-z Sagittal plane
x-y Frontal plane
x-z Transverse plane
c. Internal dimension between front posts joined
d. Internal dimension between front posts moved apart
t. Elliptical movement plate trajectory
l1. Maximum length of the mechanical leg
l2. Minimum length of the mechanical leg
h1. Maximum extension height of lift handles
h2. Minimum extension height of lift handles
PA. Patient
p1. Position of hands on handles “2” of the lift crossbar during lifting, weighing of the patient
p2. Position of hands on the handles “1” extending from the pelvic control units,
u. Rehabilitation harness
u1. Strap rope
u2. Strap rope attachment eyelet

1. A stationary automated device for lower limb rehabilitation, comprising a tripod with two vertical guides “1” (2.2.1) of the mechanical legs (2.3a, 2.3b), which girdle the patient's lower limbs from the outside by: pelvic control units (2.4) that induce in both mechanical legs (2.3a, 2.3b) a symmetrically alternating movement of the hip joint hinges (2.3.1) with spatial trajectories that are ellipsoidal in the sagittal plane (y-z) view with the longitudinal axis being horizontal, and by adjustable thigh (2.3.4) and shank (2.3.5) connectors and foot connectors (2.3.6) actuated by tilt units (2.5), further provided with a back hold (3.2) whose position is adjustable in the sagittal plane (y-z) and tiltably relative to the vertical (y) and horizontal (x) axes of the Cartesian spatial coordinate system (x, y, z), wherein all drives of the moving parts of the automated device are controlled by signals from a software-equipped computer with the monitoring of the position and of the forces present by measuring sensors (2.5.3), characterised in that the tripod is in the form of a flat platform (1) with two vertical front posts (2a, 2b) and two vertical rear posts (3a, 3b) located symmetrically relative to the sagittal plane (y-z), wherein the front posts (2a, 2b) are slidably mounted in a horizontal guide “1” (2.1.1) provided inside the platform (1) in the frontal plane (x-y) and are symmetrically moved by the spacing adjustment mechanism (2.1.2) within the range between the position of the joined front posts (2a, 2b) to a dimension (c) between their inner surfaces equal to the width of the wheelchair and the moved apart position to a dimension (d) where the width dimension of the wheelchair is located between the mechanical legs (2.3a, 2.3b) suspended on the front posts (2a, 2b), wherein further each front post (2a, 2b) has integrated vertical guides “1” (2.2.1) on the inner face parallel to the sagittal plane (y-z) with a screw drive (2.2.4, 2.2.2, 2.2.3) of the pelvic height adjustment mechanism (2.2) which is connected to the hip joint hinge (2.3.1) of the mechanical leg (2.3a, 2.3b) coupled to the patient by the thigh (2.3.7), shank (2.3.8) and foot (2.3.9) holders, wherein the rear posts (3a, 3b) are fixedly mounted to the platform (1) with the inner faces spaced apart by a distance equal to the dimension (c) between joined front posts (2a, 2b), and, moreover, they have integrated vertical guides “2” (3.1.1) for two symmetrically actuated lift brackets (3.1.2), connected at their upper ends by supporting members “2” (3.1.3) with the lifter “1” (3.1.6) positioned forward in the sagittal plane (y-z) and ending in a crossbar (3.1.8) with two handles “2” (3.1.9) for the patient's (PA) hands, and that the back hold (3.2) with the elastic cushion (3.2.6) is mounted at the end of the tiltable supporting member “3’ (3.2.3) connected by the other end, through a hinge (3.2.2) with a vertical rotation axis, to the slide (3.2.1) embedded in a vertical guide “2” (3.1.1) of one of the lift brackets (3.1.2).

2. The automated device according to claim 1, characterised in that the spacing adjustment mechanism (2.1) of the front posts (2a, 2b) comprises a servomotor “1” (2.1.2) actuating, by a pulley transmission belt (2.1.3) with a double-toothed belt (2.1.4) two screw transmissions “1” (2.1.5), whose screws (2.1.6), positioned perpendicularly and extending to opposite sides from the sagittal plane (y-z), are connected to the nuts “1” (2.1.7) mounted to both front posts (2a, 2b).

3. The automated device according to the claim 1, characterised in that the pelvic control unit (2.4) has a spacer plate (2.4.1) connected by a screw drive (2.2.4, 2.2.2, 2.2.3) integrated in the front post (2a, 2b), and it has a support (2.4.1) mounted to the spacer plate (2.4.2) with a horizontal drive consisting of a servomotor “3” (2.4.3), belt transmission “1” (2.4.4) and screw transmission “2” (2.4.5) and horizontal guides “2” (2.4.6), which are located in a plane parallel to the sagittal plane (y-z), wherein an elliptical movement plate (2.4.2) attached to the support (2.4.7), which is connected by supporting members “1” to the hip joint hinge brackets (2.4.9) and by the tilt unit (2.5) to the hip joint hinge (2.3.1) of the mechanical leg (2.3a, 2.3b).

4. The automated device according to the claim 1, characterised in that to the lift brackets (3.1.2) there are supporting members “2” (3.1.3) fixedly attached that extend towards the front posts (2a, 2b) and are connected at their ends by two parallel front (3.1.4) and rear (3.1.5) bars, wherein on the front bar (3.1.4), there is mounted on a bearing a lifter “1” (3.1.6), composed of two parallel brackets (3.1.7) which at the ends above the front posts (2a, 2b) are connected by a crossbar (3.1.8) to the handles “2” (3.1.9) for the patient's hands, and at the ends located at the rear bar (3.1.5) are connected to a patient weight sensor (3.1.10) with a display that is mounted on said bar (3.1.5).

5. The automated device according to the claim 1, characterised in that the back hold (3.2) has horizontal guides “3” (3.2.4) of the lifter “2” (3.2.5) ending with an elastic cushion (3.2.12), which is mounted on a bearing plate 3.2.11, yieldingly connected to the lifter “2” 3.2.5 by a vertical tilt axis 3.2.10, supporting member 3.2.15 and nut 3.2.16 with a lifting screw 3.2.9, actuated by a servomotor “6” 3.2.17 by a belt transmission “3” 3.2.18, and that it is provided with a hold handle 3.2.13 and a controller for locking the support position on the casing 3.2.14.

6. The automated device according to the claim 1, characterised in that the brackets (2.5.1) of the tilt units (2.5) actuating the hip (2.3.1), knee (2.3.2) and ankle (2.3.3) joints are provided with cut-outs (2.5.2) increasing their susceptibility to elastic strain, and that resistance strain gauges (2.5.3) are attached with an adhesive to the front and side faces of said brackets (2.5.1), whose signals are transmitted to the controller of the automated device.
